(19) United States
(12) Patent Application Publication
(10) Pub. No.: US 2023/0113798 A1
(43) Pub. Date: Apr. 13, 2023

(54) SUBSCRIPTION FULFILLMENT COST

(71) Applicant: Hewlett-Packard Development Company, L.P., Spring, TX (US)

(72) Inventors: Sheena Rose Chen, Vancouver, WA (US); Dean H Ouchida, Vancouver, WA (US); Ruben Alfonso Infante, Vancouver, WA (US); Daniel De La Garza Arrequin, Vancouver, WA (US); Erick Jose Romero, Vancouver, WA (US); Stephanie Marie Fiddy, Vancouver, WA (US); Saiprabha Sundaram, Vancouver, WA (US)

(21) Appl. No.: 17/907,309

(22) PCT Filed: Apr. 20, 2020
(86) PCT No.: PCT/US2020/028944

§ 371 Date: Sep. 26, 2022

(51) Int. Cl. G06Q 10/0834; G06Q 10/0635

(52) U.S. Cl. CPC G06Q 10/08345; G06Q 10/0635

(57) ABSTRACT

Example implementations relate to subscription fulfillment costs. Some examples include a non-transitory machine-readable medium containing instructions executable by a processor to cause the processor to determine a cost to deliver a first size of the consumable based on a supply production cost of the first size and a fulfillment cost of the first size, determine a cost to deliver a second size of the consumable based on a supply production cost of the second size and a fulfillment cost of the second size, determine a cost of consumable waste of the first size based on a received cancellation risk, the cost to deliver the first size, and the cost to deliver the second size, and determine a cost of consumable waste of the second size based on the cancellation risk, the cost to deliver the first size, and the cost to deliver the second size.

### BACKGROUND

A subscription offers periodic (e.g., monthly, yearly, seasonal, etc.) use or access to a product (e.g., a consumable) or service. A subscriber (individual, group, company, etc.) agrees to make a payment in order to receive or participate in something. Renewal of a subscription may be periodic and activated automatically so that the cost of a new period is automatically paid for by a pre-authorized charge to a payment account.

### BRIEF DESCRIPTION OF THE DRAWINGS

FIG. 1 illustrates a system for analyzing subscription fulfillment cost according to an example;

FIG. 2 illustrates a diagram of a controller including a processor, a memory resource, and instructions according to an example;

FIG. 3 illustrates a method for analyzing subscription fulfillment cost according to an example; and

FIG. 4 illustrates a subscription fulfillment cost analysis according to an example.

### DETAILED DESCRIPTION

Consumables are products that consumers use recurrently, (e.g., items which “get used up”, recycled, or discarded). For example, consumable office supplies include products such as paper, pens, file folders, notepads, and toner or ink cartridges.

Subscription-based services may be based on deliveries of consumables to subscribers before the consumable is depleted (e.g., consumables connected to Internet of Things (IoT) devices, office supplies, cosmetics, etc.). Subscription fees in such approaches may be based on fixed usage rates and may favor larger consumables to reduce shipping and handling costs. Such approaches may lead to inefficient (e.g., incomplete) usage of the consumable and can result in consumable waste. For instance, a subscriber may cancel a subscription after receiving a larger consumable, resulting in waste if the subscriber does not use the larger consumable completely, in addition to lost profits if the provider did not receive a full subscription payment. A subscription, in some instances, may allow for cancellation at any time. For example, a user may cancel the subscription with or without notice after a month, two weeks, two years, etc. with or without penalty.

For example, with respect to printing services, subscription printing services may include automatic replenishment of consumables (e.g., printing supplies) such as printing fluid (e.g., printing fluid cartridges such as ink cartridges, toner cartridges, etc.). Subscribers may be shipped larger capacity supplies to reduce shipment costs to the provider. In such an approach, the subscriber may be sent a supply to cover one thousand printed pages but may cancel their subscription after just one hundred print printed pages. This results in wasted consumables and lost profits to the provider.

In contrast, examples of the present disclosure consider a subscriber's subscription cancellation risk (herein after referred to as a “cancellation risk”) when determining which type (e.g., size) of consumable to provide to a subscriber. As used herein, a subscriber can be a single user, a plurality of users sharing a subscription, a business with a single location, a business with a plurality of locations, a device, or a plurality of devices, among others. As used herein, a consumable includes an item intended to be used up and then replaced.

Some examples include retrieving a cancellation risk for the subscriber and using that cancellation risk to create a cost model for the consumable including, for instance, packaging, handling, freight, etc. for the consumable. The cost model can be used to determine which type, for instance what size, of the consumable to send to the subscriber to reduce costs of consumable waste and reduce lost profits for the provider.

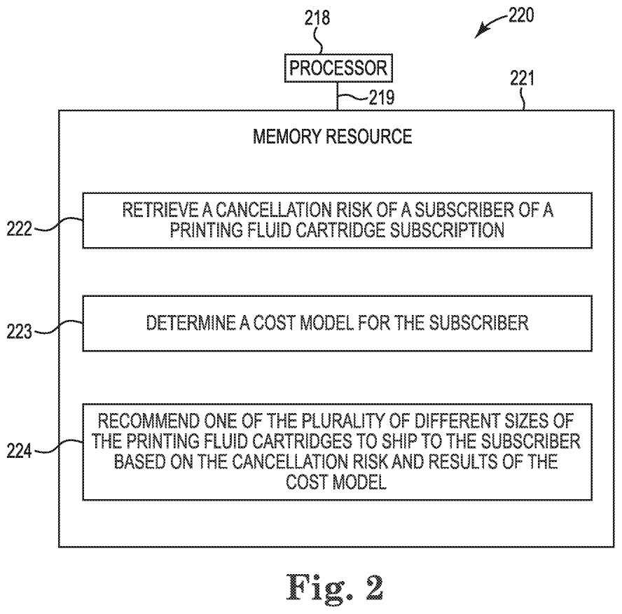

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Multiple analogous elements within one figure may be referenced with a reference numeral followed by a hyphen and another numeral or a letter. For example, 450-1 may reference element 50-1 in FIG. 4 and 450-2 may reference element 50-2, which can be analogous to element 50-1. Such analogous elements may be generally referenced without the hyphen and extra numeral or letter. For example, elements 450-1 and 450-2 may be generally referenced as 450.

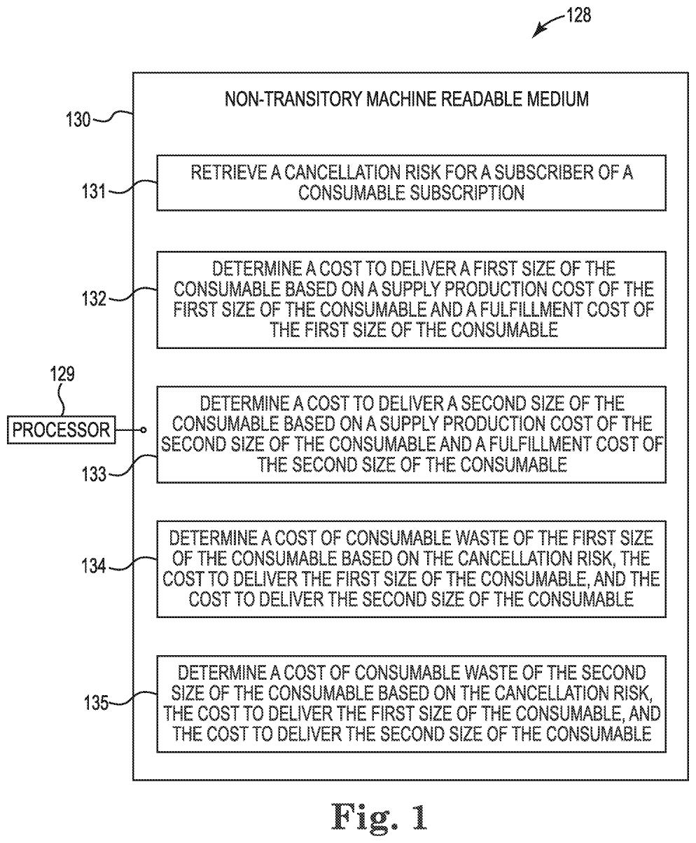

FIG. 1 illustrates a system for analyzing subscription fulfillment cost according to an example. System 128 can be a computing device in some examples and can include a processor 129. System 128 can further include a non-transitory machine-readable medium (MRM) 130, on which may be stored instructions, such as instructions 131, 132, 133, 134, and 135. Although the following descriptions refer to a processor and a memory resource, the descriptions may also apply to a system with multiple processors and multiple memory resources. In such examples, the instructions may be distributed (e.g., stored) across multiple non-transitory MRMs and the instructions may be distributed (e.g., executed by) across multiple processors.

Non-transitory MRM 130 may be electronic, magnetic, optical, or other physical storage device that stores executable instructions. Thus, non-transitory MRM 130 may be, for example, Random Access Memory (RAM), an Electrically-Erasable Programmable ROM (EEPROM), a storage drive, an optical disc, and the like on-transitory MRM 130 may be disposed within system 128, as shown in FIG. 1. In this example, the executable instructions 131, 132, 133, 134, and 135 can be “installed” on the device. Additionally and/or alternatively, non-transitory MRM 130 can be a portable, external or remote storage medium, for example, that allows system 128 to download the instructions 131, 132, 133, 134, and 135 from the portable/external/remote storage medium. In this situation, the executable instructions may be part of an “installation package”. In some examples, the executable instructions may be performed in real time. As described herein, non-transitory MRM 130 can be encoded with executable instructions for analyzing subscription fulfillment cost.

Instructions 131, when executed by a processor such as processor 129, can include instructions to retrieve a cancellation risk for a subscriber of a consumable subscription. For instance, a cancellation risk can include a likelihood of a subscriber canceling a subscription within a given time period. For instance, a subscriber determined to be likely to cancel a monthly subscription within a month may have a higher cancellation risk than a subscriber determined to be likely to cancel a monthly subscription within a year. The cancellation risk, for instance, can be retrieved from memory such as non-transitory MRM 130, other memory, or an external source.

Instructions 132, when executed by a processor such as processor 129, can include instructions to determine a cost to deliver a first size of the consumable based on a supply production cost of the first size of the consumable and a fulfillment cost of the first size of the consumable. Instructions 133, when executed by a processor such as processor 129, can include instructions to determine a cost to deliver a second size of the consumable based on a supply production cost of the second size of the consumable and a fulfillment cost of the second size of the consumable. In some examples, the first size is smaller than the second size.

Cost to deliver a consumable (or service) includes the cost to the provider of the consumable from the start of production of the consumable until delivery to the subscriber. The supply production cost of the consumable can include costs incurred by the provider from manufacturing the consumable. A supply production cost can include a plurality of expenses, such as labor, raw materials, consumable manufacturing supplies, and general overhead. The fulfillment cost of the consumable includes the price to deliver (e.g., ship, packaging, procession, other labor costs, etc.) the consumable to the subscribers. The supply production cost of the consumable can include the supply production cost of the consumable combined with the fulfillment cost of the consumable,

Instructions 134, when executed by a processor such as processor 129, can include instructions to determine a cost of consumable waste of the first size of the consumable based on the cancellation risk, the cost to deliver the first size of the consumable, and the cost to deliver the second size of the consumable. Instructions 135, when executed by a processor such as processor 129, can include instructions to determine a cost of consumable waste of the second size of the consumable based on the cancellation risk, the cost to deliver the first size of the consumable, and the cost to deliver the second size of the consumable.

For instance, the cost of consumable waste can include a cost to the provider for the consumable that is dependent on how much of the supply of the consumable the subscriber uses before cancellation of the subscription. Put another way, the cost of consumable waste can include the cost to deliver the consumable over a projected subscription lifetime. For instance, a subscriber that uses less of a consumable (e.g., five hundred pages of a one-thousand-page capacity toner cartridge) before canceling their subscription results in a higher cost of consumable waste to a provider as compared to a subscriber that uses more of the consumable (e.g., nine hundred pages of a one thousand page capacity toner cartridge) before canceling their subscription.

In some instances, the instructions can be executable to determine the cost of consumable waste of the first size of the consumable and the second size of the consumable based on a consumable consumption velocity of the subscriber. A consumable consumption velocity can include the speed at which the subscriber uses up the consumable. For instance, a first subscriber may on average use up a first size consumable in three weeks and a second size consumable in six weeks, while a second subscriber may on average use up the first size consumable in four weeks and the second size consumable in twelve weeks. A consumable consumption velocity can, for instance, be used to determine how to reduce a stranded supply of the consumable (e.g., how much delivered to a subscriber and left unpaid for) while maintaining or increasing profits.

In some examples, the instructions can be executable to determine the cost of consumable waste of the first size of the consumable based on the estimated cost of the stranded supply of the first size of the consumable and determine the cost of consumable waste of the second size of the consumable based on the estimated cost of the stranded supply of the second size of the consumable. As used herein, a stranded supply can include an amount of the consumable that was delivered to a subscriber and not paid for. For instance, if a subscriber is sent a toner cartridge containing a three-month supply of toner, but the subscriber cancels their subscription after one month, the stranded supply is a two-month supply of toner,

The instructions can be executable to determine the estimated cost of a stranded supply of the first size of the consumable based on the cost to deliver the first size of the consumable and a predicted stranded supply of the first size of the consumable and to determine the estimated cost of a second size of the consumable based on the cost to deliver the second size of the consumable and a predicted stranded supply of the second size of the consumable. For instance, a stranded supply prediction can include determining the lesser of an average stranded supply of a subscriber (e.g., an amount a subscriber, on average, discards before replacing with a newly received consumable) and a worst-case stranded supply (e,g,, the subscriber replaces the consumable upon arrival of a new consumable even if supply remains). Using the stranded supply prediction, the estimated cost of the stranded supply can be determined, in some examples, by multiplying the estimated stranded supply by the cost to deliver the consumable.

In some examples, the instructions can be executable to recommend shipment of one of the first size or the second size of the consumable having the smaller cost of consumable waste. While two different sizes and particular shipment frequencies are described with respect to FIG. 1, more than two different sizes may be compared, and shipments may be done at different frequencies, for instance bi-monthly or dependent on the subscribers average supply velocity.

In some examples, determining which size consumable to provide to a subscriber can include the use of a cost model, which may be dependent on controlled elements, constant elements, variable elements, and calculated elements. For example, controlled elements can include supply production cost and supply capacities (e.g., how much supply the consumable can hold), Elements that may be constants can include a fulfillment shipping cost, a fulfillment shipping time to deliver, and a billing cycle duration (e.g., days, month(s)), etc.). In some examples, elements that may be variable can include an average stranded supply, a worst-case stranded supply (e.g., at arrival), a current supply remaining, an average supply velocity, a lifetime until cancellation (e.g., how many days until the subscriber is expected to cancel their subscription), a base plan cost (e.g., cost of the subscription to the subscriber), and an average overage cost (e.g., average cost to the subscriber for overages (e.g., page overages)).

Using the controlled elements, constant elements, and variable elements, additional elements can be determined. These can include, for instance, a supply predicted revenue, a cost to deliver, a profit, a predicted stranded supply, a current supply lifetime, a new shipped supply lifetime, and a supply lifetime in billing cycles rounded up. For instance, the supply predicted revenue can include the sum of the base plan cost plus the overage cost multiplied by the supply lifetime in billing cycles rounded up. The cost to deliver can include the supply production cost plus the fulfillment shipping cost. The profit can include the supply predicted revenue minus the cost to deliver.

In some instances, the predicted stranded supply can be the smaller of the average stranded supply and the worst-case stranded supply (e.g., at arrival). The current supply lifetime can include the current supply remaining minus the predicted stranded supply, with that different then divided by the average supply velocity. In some examples, determining the new shipped supply lifetime (e.g., how long the replacement consumable may last) can include comparing the sum of the fulfillment shipping time to deliver, the current supply lifetime, and the supply capacity divided by the average supply capacity and the lifetime until cancellation. The smaller of the two can be the new shipped supply lifetime, which can be used for early cancellation mitigation. The supply lifetime in billing cycles rounded up can include the new shipped supply lifetime divided by the billing cycle duration in days. For example, the supply lifetime in billing cycles rounded up can determine how many recurring monthly charges a provider may expect before cancellation of the subscription. In some examples, the different determinations and the controlled, constant, and variable elements can be used to reduce the cost to deliver the consumable by selecting a particular supply and assessing a cancellation risk in order to increase profit.

FIG. 2 illustrates a diagram of a controller 220 including a processor 218, a memory resource 221, and instructions 222, 223, and 224, according to an example. For instance, the controller 220 can be a combination of hardware and instructions for subscription fulfillment cost analysis. The hardware, for example can include a processor 218 and/or a memory resource 221 (e.g., MRM, computer-readable medium (CRM), data store, etc.).

The processor 218, as used herein, can include a number of processing resources capable of executing instructions stored by a memory resource 221. The instructions (e.g., machine-readable instructions (MRI)) can include instructions stored on the memory resource 221 and executable by the processor 218 to implement a desired function (e.g., subscription fulfillment cost analysis). The memory resource 221, as used herein, can include a number of memory components capable of storing non-transitory instructions 222, 223, and 224 that can be executed by processor 218. Memory resource 221 can be integrated in a single device or distributed across multiple devices. Further, memory resource 221 can be fully or partially integrated in the same device as processor 218 or it can be separate but accessible to that device and processor 218. Thus, it is noted that the controller 220 can be implemented on an electronic device and/or a collection of electronic devices, among other possibilities.

The memory resource 221 can be in communication with the processor 218 via a communication link (e.g., path) 219. The communication link 219 can be local or remote to an electronic device associated with the processor 218. The memory resource 221 includes instructions 222, 223, and 224. The memory resource 221 can include more or less instructions than illustrated to perform the various functions described herein. The instructions 222, 223, and 224 (e.g., software, firmware, etc.) can be downloaded and stored in the memory resource 221 (e.g., MRM) as well as a hard-wired program (e.g., logic), among other possibilities.

Instructions 222, when executed by a processor such as processor 218, can include instructions to retrieve a cancellation risk of a subscriber of a printing fluid cartridge subscription. The cancellation risk can include a likelihood of a subscriber canceling a subscription within a given time period. In some examples, the cancellation risk can include a projected length of subscription (e.g., 1 month, 2 months, 1 year, etc.). A subscriber determined to have a projected length of subscription of one month may have a higher cancellation risk than a subscriber determined to have a projected length of subscription of one year. The cancellation risk, in some examples, can be retrieved from memory such as non-transitory memory resource 221, other memory, or an external source.

Instructions 223, when executed by a processor such as processor 218, can include instructions to determine a cost model for the subscriber. The cost model can be based on, for instance, a supply production cost of each of a plurality of different sizes of the printing fluid cartridge, a fulfillment cost of each of the plurality of different sizes of the printing fluid cartridge, and a stranded supply of printing fluid of each of the plurality of different sizes of the printing fluid cartridge, among others. For instance, the cost model can include determining a cost to deliver each of the plurality of different sizes of the printing fluid cartridge which can be the sum of the supply production cost and the fulfillment shipping costs. The stranded supply can be used as a part of the cost model to determine a size of the printing fluid cartridge that results in reduced waste. Other elements (e.g., supply predicted revenue, profit, current supply lifetime, etc.) as previously described may be used in the cost model.

In some examples, the instructions are executable to determine the cost model based on a predicted stranded supply of each of the plurality of different sizes of the printing fluid cartridge, wherein the predicted stranded supply is one of an average stranded supply for the subscriber, a worst-case stranded supply for the subscriber, and a supply capacity of the relevant printing fluid cartridge. For instance, a subscriber who has a history of using up a printing fluid cartridge before replacing the printing fluid cartridge, even upon arrival of a replacement printing fluid cartridge may have a low average stranded supply. A worst-case stranded supply can include a supply left when a subscriber replaces the printing fluid cartridge upon arrival of the replacement printing fluid cartridge, leaving supply stranded in the replaced printing fluid cartridge. The supply capacity includes how much printing fluid the printing fluid cartridge can hold upon production.

In some examples, the results of the cost model comprise a cost of wasted printing fluid for each of the plurality of different sizes of the printing fluid cartridge. For instance, the cost of the wasted printing fluid includes a cost of a stranded supply or predicted stranded supply upon cancellation of a subscription. For instance, if a subscriber is sent a three-month supply of printing fluid, but uses two months' worth and cancels their subscription, the cost of wasted printing fluid can include the cost to the provider of the one month's supply that remains but was not paid for.

Instructions 224, when executed by a processor such as processor 218, can include instructions to recommend one of the plurality of different sizes of the printing fluid cartridges to ship to the subscriber based on the cancellation risk and results of the cost model. For example, the instructions can be executable to estimate when the subscriber will run out of printing fluid in each of the plurality of different sizes of the printing fluid cartridge, and the recommendation can be based on the estimate. The estimate can be compared to supply production costs and fulfillment shipping costs to determine which size printing fluid cartridges reduce the cost to deliver the associated printing fluid cartridge, and a particular size can be recommended (e.g., a particular printing fluid cartridge size having a lowest cost to deliver).

Similar, in some instances, the instructions can be executable to compare a supply lifetime of each of the plurality of different sizes of the printing fluid cartridge to the cancellation risk of the subscriber, and the supply lifetime comparison can be used in the recommendation determination. For instance, if the supply lifetime is one month, and the cancellation risk is low (e.g., projected life of subscription of one year), a recommendation may be made to ship a larger supply lifetime printing fluid cartridge to reduce fulfillment costs as compared to shipping multiple smaller supply lifetime printing fluid cartridges.

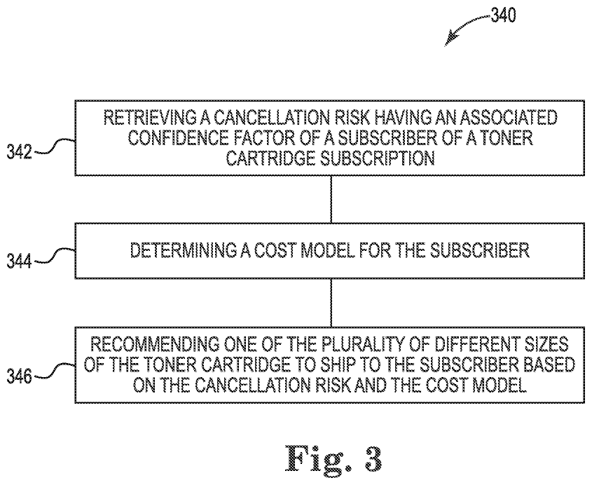

FIG. 3 illustrates a method for analyzing subscription fulfillment cost according to an example. The method 340 may be performed by a system 128 and/or controller 220 as described with respect to FIGS. 1 and 2. At 342, the method 340 includes retrieving a cancellation risk having an associated confidence factor of a subscriber of a toner cartridge subscription. For instance, retrieving the cancellation risk comprises retrieving a quantification of a likelihood of the subscriber to cancel the subscription within a particular time frame.

At 344, the method 340 includes determining a cost model for the subscriber. The cost model, for instance, considers a plurality of elements used to determine how to reduce a cost to deliver the toner cartridge over a subscription lifetime. This can reduce toner waste and increase profits, for example. Determining the cost model for the subscriber can include determining the cost model associated with the toner cartridge, packaging of the toner cartridge, handling of the toner cartridge, and shipping of the toner cartridge. For example, the cost model can consider costs associated with production, handling, and/or delivery of the toner cartridge. Additionally or alternatively, the cost model can be based on the cancellation risk, a supply production cost of each of a plurality of different sizes of the toner cartridge, a fulfillment cost of each of the plurality of different sizes of toner cartridge, and an estimated toner waste amount of each of the plurality of different sizes of the toner cartridge over a lifetime of the subscription, among others.

In some examples, the method 340 can include determining a supply lifetime of the toner in the toner cartridge in billing cycles (e.g., rounded up) for each of the plurality of different sizes of the toner cartridge. The supply lifetime can be used in the determination of the cost model, in some instances. For example, determining how much toner may be consumed in each billing cycle and/or how much toner may remain at the end of a billing cycle can be used to determine which size toner cartridge to provide to a subscriber. For instance, if it is determined that the subscriber may have somewhere between a one- and two-month supply (e.g., rounded up to two months) at the end of the next billing cycle and has a projected life of subscription of one month, the cost model may indicate sending a smaller toner cartridge with a smaller supply to prevent potential wasted toner and extra costs associated with a larger toner cartridge having a larger supply (e.g., greater than one month). Conversely, if the projected life of subscription is six months, the cost model may indicate providing a larger toner cartridge with larger supply to reduce shipping costs associated with hipping multiple cartridges over multiple months.

In some instances, the method 340 can include determining a predictive revenue for each of the plurality of different sizes of the toner cartridge. The predictive revenue can be used in the determination of the cost model, in some instances. For instance, the predicted revenue can be based on a base plan cost of the associated toner cartridge, an average overage cost, and the supply lifetime in billing cycles rounded up. The cost model, in some instances, may indicate providing a toner cartridge size having the highest predictive revenue.

At 346, the method 340 includes recommending one of the plurality of different sizes of the toner cartridge to ship to the subscriber based on the cancellation risk and the cost model. The recommendation, for instance, can be made based on the cost model indicating a particular size or sizes of toner cartridge reducing waste, increasing profits, and/or reducing a cost to deliver the toner cartridge, among others.

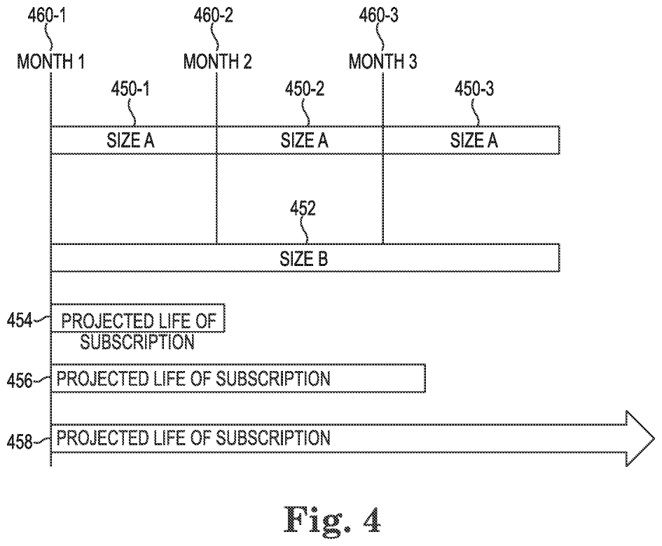

FIG. 4 illustrates a subscription fulfillment cost analysis according to an example. FIG. 4 illustrates example scenarios for two different size consumables and three different projected lives of subscriptions. For instance, based on a cancellation determination, it may be determined that a subscriber has a projected life of subscription of one month 454, two months 456, or more than three months 458. Based on these projected lives of subscriptions, determinations can be made with respect to which size consumable should be provided to the subscriber. While two different sizes and monthly shipments are described with respect to FIG. 4, more than two different sizes may be compared, and shipments may be done at different frequencies, for instance bi-monthly or dependent on the subscriber's average supply velocity.

In the example illustrated in FIG. 4, a consumable of size B 452 can include a three-month supply of a consumable such as printing toner. A consumable of size A 450-1, 450-2, 450-3 can include a one-month supply of the consumable such as printing toner. Shipping the consumable 450 may be more expensive over a three-month span than shipping the consumable 452 because the consumable 450-1 would be shipped ahead of Month 1 460-1, the consumable 450-2 would be shipped ahead of Month 2 450-2, and the consumable 450-3 would be shipped ahead of Month 3 450-3 to satisfy the subscription. In contrast, the consumable 452 would be shipped one time ahead of month 1 460-1. Supply production cost of the larger consumable 452 may be larger than supply production cost of the smaller consumable 450, in some examples.

If the subscriber has a projected life of subscription 454 of one month, the cost to deliver the consumable 450 may be lower than the cost to deliver the consumable 452. For instance, if the supply production cost for the consumable 450 is $40 and the shipping cost per unit is $5, the cost to deliver the consumable 450 is $45. In contrast, if the supply production cost for the consumable 452 is $100 with a shipping cost of $5 per unit, the cost to deliver the consumable 452 is $105. Two months of consumable supply may be wasted shipping the consumable 452.

If the subscriber has a projected life of subscription 458 of three or more months, the cost to deliver the consumable 450 over three months may be higher than the cost to deliver the consumable 452. For instance, if the supply production cost for the consumable 450 is $40 and the shipping cost per unit is $5, the cost to deliver the consumable 450 is $40×3+$5×3=$135. In contrast, if the supply production cost for the consumable 452 is $100 with a shipping cost of $5 per unit, the cost to deliver the consumable 452 is $105.

If the subscriber has a projected life of subscription 456 of two months, the cost to deliver the consumable 450 may be similar to the cost to deliver the consumable 452. For instance, the cost to deliver the consumable 450 may be $90 ($40×2+$5×2=$90), while the cost to deliver the consumable 452 may be $105 ($100+$5). One month of consumable supply may be wasted shipping the consumable 452.

In the example associated with FIG. 4, it is assumed that consumables are shipped based on a monthly calendar and that the lifespan of the consumable 450 is one month, and the lifespan of the consumable 452 is three months. Examples are not so limited. For instance, shipments may be sent based on a subscriber's use history (e.g., per page limits of toner cartridges), and a consumable may have a lifespan based on factors other than months (e.g., lifespan of one thousand pages). Supply production costs, shipping costs, and costs to deliver may be different for different consumables.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A non-transitory machine-readable medium containing instructions executable by a processor to cause the processor to:
retrieve a cancellation risk for a subscriber of a consumable subscription;
determine a cost to deliver a first size of the consumable based on a supply production cost of the first size of the consumable and a fulfillment cost of the first size of the consumable;
determine a cost to deliver a second size of the consumable based on a supply production cost of the second size of the consumable and a fulfillment cost of the second size of the consumable;
determine a cost of consumable waste of the first size of the consumable based on the cancellation risk, the cost to deliver the first size of the consumable, and the cost to deliver the second size of the consumable; and
determine a cost of consumable waste of the second size of the consumable based on the cancellation risk, the cost to deliver the first size of the consumable, and the cost to deliver the second size of the consumable.

2. The medium of claim 1, further comprising instructions executable to recommend shipment of one of the first size or the second size of the consumable having the smaller cost of consumable waste.

3. The medium of claim 1, wherein the consumable is a toner cartridge.

4. The medium of claim 1, further comprising the instructions executable to:
determine the cost of consumable waste of the first size of the consumable based on a consumable consumption velocity of the subscriber; and
determine the cost of consumable waste of the second size of the consumable based on the consumable consumption velocity of the subscriber.

5. The medium of claim 1, further comprising the instructions executable to:
estimate a cost of a stranded supply of the first size of the consumable based on the cost to deliver the first size of the consumable and a predicted stranded supply of the first size of the consumable;
estimate a cost of a stranded supply of the second size of the consumable based on the cost to deliver the second size of the consumable and a predicted stranded supply of the second size of the consumable;
determine the cost of consumable waste of the first size of the consumable based on the cost of the stranded supply of the first size of the consumable; and
determine the cost of consumable waste of the second size of the consumable based on the cost of the stranded supply of the second size of the consumable.

6. A controller comprising a processor in communication with a memory resource including instructions executable to;
retrieve a cancellation risk of a subscriber of a printing fluid cartridge subscription;
determine a cost model for the subscriber based on:
the cancellation risk;
a supply production cost of each of a plurality of different sizes of the printing fluid cartridge;
a fulfillment cost of each of the plurality of different sizes of the printing fluid cartridge; and
a stranded supply of printing fluid of each of the plurality of different sizes of the printing fluid cartridge; and
recommend one of the plurality of different sizes of the printing fluid cartridges to ship to the subscriber based on the cancellation risk and results of the cost model.

7. The controller of claim 6, wherein the results of the cost model comprise a cost of wasted printing fluid for each of the plurality of different sizes of the printing fluid cartridge.

8. The controller of claim 6, further comprising the instructions executable to determine the cost model based on a predicted stranded supply of each of the plurality of different sizes of the printing fluid cartridge, wherein the predicted stranded supply is one of an average stranded supply for the subscriber, a worst-case stranded supply for the subscriber, and a supply capacity of the relevant printing fluid cartridge.

9. The controller of claim 6, further comprising the instructions executable to:
estimate when the subscriber will run out of printing fluid in each of the plurality of different sizes of the printing fluid cartridge; and
recommend one of the plurality of different sizes of the printing fluid cartridges to ship to the subscriber based on the cancellation risk, results of the cost model, and the estimation of when the subscriber will run out of the printing fluid in each of the plurality of different sizes of the printing fluid cartridge.

10. The controller of claim 6, comprising the instructions executable to:
compare a supply lifetime of each of the plurality of different sizes of the printing fluid cartridge to the cancellation risk of the subscriber; and
recommend one of the plurality of different sizes of the printing fluid cartridges to ship to the subscriber based on the cancellation risk, results of the cost model, and comparison.

11. A method, comprising:
retrieving a cancellation risk having an associated confidence factor of a subscriber of a toner cartridge subscription;
determining a cost model for the subscriber based on:
the cancellation risk;
a supply production cost of each of a plurality of different sizes of the toner cartridge;
a fulfillment cost of each of the plurality of different sizes of toner cartridge; and
an estimated toner waste amount of each of the plurality of different sizes of the toner cartridge over a lifetime of the subscription; and
recommending one of the plurality of different sizes of the toner cartridge to ship to the subscriber based on the cancellation risk and the cost model,
wherein the recommended one of the plurality of different sizes of the toner cartridge has a lower toner waste amount over the lifetime of the subscription as compared to the remaining sizes of the plurality of different sizes of the toner cartridge.

12. The method of claim 11, further comprising:
determining a supply lifetime of the toner in the toner cartridge in billing cycles for each of the plurality of different sizes of the toner cartridge; and
determining the cost model based on the determined supply lifetime of the toner.

13. The method of claim 11, further comprising:
determining a predicative revenue for each of the plurality of different sizes of the toner cartridge; and
determining the cost model based on the determined predicative revenue of the toner.

14. The method of claim 11, wherein retrieving the cancellation risk comprises retrieving a quantification of a likelihood of the subscriber to cancel the subscription within a particular time frame.

15. The method of claim 11, wherein determining the cost model for the subscriber comprises determining the cost model associated with the toner cartridge, packaging of the toner cartridge, handling of the toner cartridge, and shipping of the toner cartridge.
